(19) United States
(12) Patent Application Publication
(10) Pub. No.: US 2009/0201177 A1
(43) Pub. Date: Aug. 13, 2009

(54) SECURE HEAD-UP DISPLAY

(75) Inventor: Michel Soler, Carbon-Blanc (FR)

Correspondence Address: LOWE HAUPTMAN & BERNER, LLP, 1700 DIAGONAL ROAD, SUITE 300, ALEXANDRIA, VA, 22314, US

(73) Assignee: Thales, Neuilly Sur Seine (FR)

(21) Appl. No.: 12/307,296

(22) PCT Filed: Jul. 9, 2007
(86) PCT No.: PCT/EP07/56951

§ 371 Date: Jan. 2, 2009

(30) Foreign Application Priority Data
Jul. 11, 2006 (FR) 0606308

(51) Int. Cl. G01C 23/00; G02B 27/01

(52) U.S. Cl. 340/974; 359/630

(57) ABSTRACT

The field of the invention is that of securing the necessary piloting information for aircraft cockpits.

The invention relates to a head-up display for aircraft, characterized in that it comprises means of calculating a “PFD” type symbology comprising at least the speed, altitude and attitude information, the display symbology being able to be specifically adapted to cope with cockpit smoke or fire conditions.

### CROSS-REFERENCE TO RELATED APPLICATIONS

The present Application is based on International Application No. PCT/EP2007/056951, filed on Jul. 9, 2007, which in turn corresponds to French Application No. 0606308, filed on Jul. 11, 2006, and priority is hereby claimed under 35 USC §119 based on these applications. Each of these applications are hereby incorporated by reference in their entirety into the present application.

### BACKGROUND OF THE INVENTION

1. Field of the Invention

The field of the invention is that of the securing of the necessary piloting information for aircraft cockpits.

2. Description of the Prior Art

Generally, the displays present in an aircraft cockpit are of two types. There are:
dashboard displays, also called “head down” displays, or HDD, and
so-called “head-up” displays, also known by the acronym HUD.

FIG. 1, which partly shows an aircraft dashboard as seen by the pilot, shows in bold continuous lines these different HDD and HUD displays.

The dashboard displays, or HDD, mainly comprise large screens, generally liquid crystal displays, providing the crew with the various information needed for piloting, navigating and controlling the craft. The display showing the necessary piloting information is also called PFD, the acronym standing for “Primary Flight Display”. These displays are linked by means of databuses to onboard electronic computers which generate, from information contained from various sensors, the necessary data to be displayed.

Obviously, the presentations of information are vital to the safety of the craft. Fire or the appearance of smoke in the cockpit are classified among the extremely serious incidents likely to disrupt the legibility of the information supplied by the dashboard displays. While it is, in fact, possible to partly protect the crew from the smoke by means of oxygen masks, there are only few solutions that make it possible to provide the crew with the necessary visual information for piloting when smoke enters the cockpit. In case of failure of the ventilation systems, a first solution consists in using inflatable systems inserted between the display screens and the face of the pilot. This solution, which is not universally employed, has numerous drawbacks. It is very bulky, difficult to implement and considerably limits the movements of the crew.

To overcome the above drawbacks, the patent applications US 2003/0030911 and WO 00/28281 propose integrating the critical-information presentation function in the oxygen mask. This solution has numerous drawbacks. It can be used only when the pilot wears his mask, that is, in conditions where the safety of the flight is seriously compromised. It is, of course, impossible to provide an overlay of the presented information on the outside landscape. Finally, it is a solution that is complex to implement and necessarily costly in as much as the system implemented must be of small dimensions, perfectly secure and operational in extreme conditions.

The so-called “head-up” displays, generally known by the acronym “HUD”, were first used on military airplanes, to then be rolled out in the 1980s to all types of craft. They present to the pilot visual information that is collimated in his field of vision and overlaid on the outside landscape. This visual information more particularly concerns piloting and is used notably for take-off and landing. It is thus possible to present to the pilot a synthetic runway overlaid on the landscape as indicated in FIG. 1. One of the major benefits of the “HUD” is that it makes it possible to present a so-called “conforming” image, that is, an image that perfectly corresponds to a real image.

An “HUD” therefore comprises three main parts:
An electronic computer linked to the airplane databuses;
A high-luminosity display which can be a cathode ray tube or a liquid crystal screen;
An optical system for collimating and overlaying images on the outside landscape. The overlay on the landscape is generally provided by an optical plate C called “combiner”, as can be seen in FIG. 1.

### SUMMARY OF THE INVENTION

The object of the invention is to display, in case of fire or the presence of smoke, vital piloting-related information on the head-up display.

More specifically, the subject of the invention is a head-up display for aircraft, characterized in that it comprises means of calculating a “PFD” type symbology comprising at least aircraft speed, altitude and attitude information, the head-up display being a display instrument integrated and fixed in the cockpit and presenting a collimated image.

Advantageously, the calculation means make it possible to generate several possible symbology presentation modes, at least one of the modes generating a simplified symbology comprising only the speed, altitude and attitude information.

Advantageously, the calculation means generate plots with an angular width of between 5 milliradians and 10 milliradians.

Advantageously, the calculation means generate so-called “conforming” symbols, that is, symbols representative of the outside landscape and drawn so that they have an apparent size to the same scale as said outside landscape.

Advantageously, the luminance of the displayed symbols is the maximum luminance permitted by the display.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 represents a partial view of an aircraft dashboard seen by the pilot;

FIG. 2 represents a partial view of an aircraft dashboard seen in profile;

FIG. 3 represents a first example of a PFD-type symbology generated in a head-up display;

FIG. 4 represents a second example of a PFD-type symbology generated in a head-up display;

FIG. 5 represents a third example of a PFD-type symbology generated in a head-up display.

### MORE DETAILED DESCRIPTION

The technical implementation of the invention poses no particular technical problems. All that is required, in fact, is to link either the dedicated computer to the head-up display, or the head-up display itself to the databus conveying the information needed to establish the “PFD” symbology. The creation of the “PFD” symbology specifically adapted to a presentation of collimated information poses no particular problems in as much as it does not require specific calculation or storage means. As will be seen hereinafter in the description, it can be specifically adapted to enhance the legibility of the information in case of presence of smoke in the cockpit.

The advantages of a presentation of the essential information required for piloting in the head-up display rather than on a dashboard display are significant and are detailed hereinbelow.

First Advantage: Large Field of View.

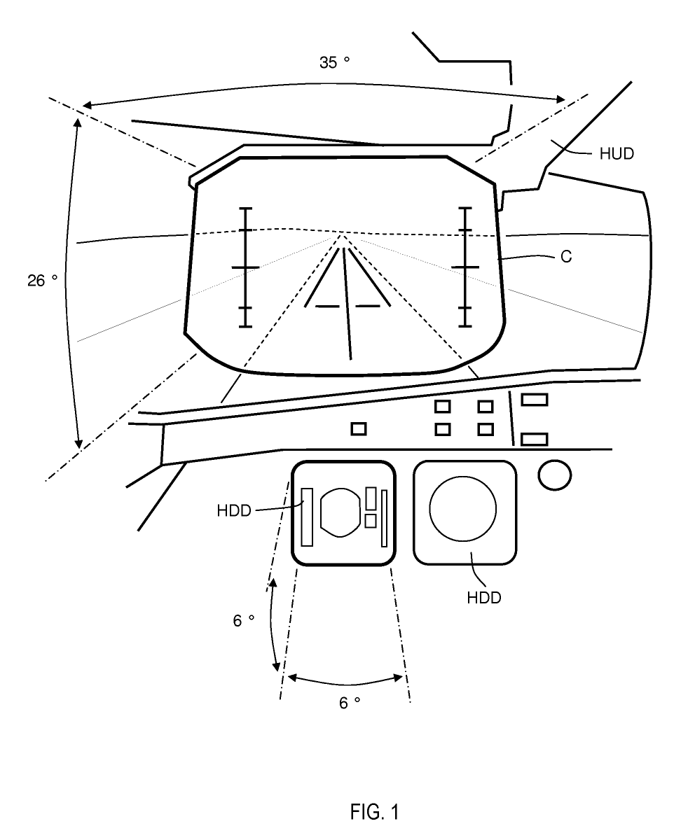

As can be seen in FIG. 1, the head-up displays present a large field of view which conventionally reaches 35 degrees in bearing and 26 degrees in elevation. The field of view of a dashboard head-down display does not exceed 6 degrees in elevation and in bearing. Consequently, it is possible to display characters of apparently much larger size in a head-up display, which increases their legibility.

Second Advantage: Proximity of the Pilot.

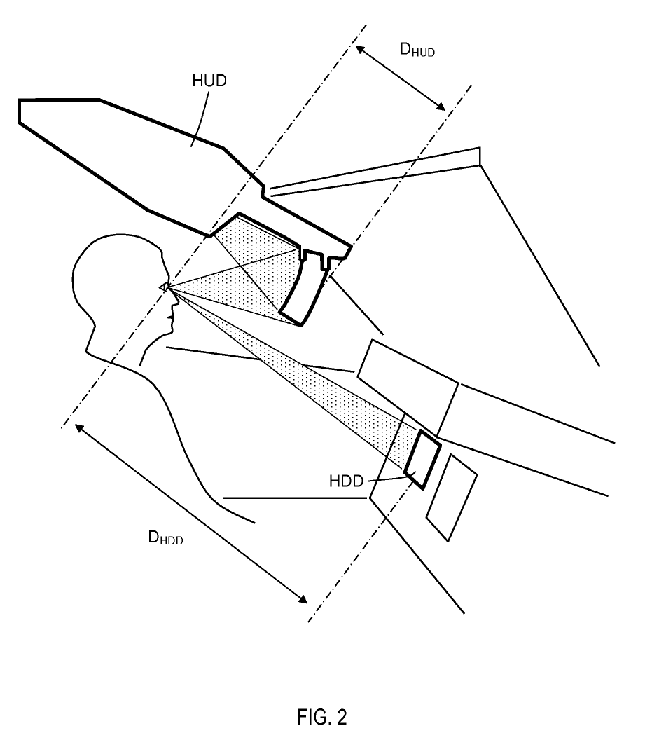

As can be seen in FIG. 2, the distance D_{HDD} separating the eye of the pilot from the readout of a head-down display is of the order of a meter whereas the distance D_{HUD} separating the eye of the pilot from the readout of a head-up display is much smaller, in the order of 0.5 meters. Consequently, on average, the presence of smoke between the pilot and a display will be greater if it is a head-down display than if it is a head-up display. The legibility of the information from a head-up display will therefore be better.

Third Advantage: High Luminance.

In principle, HUDs are designed for the collimated information to be able to be read even in cases of strong sunlight. Consequently, the maximum possible luminance and contrast in this type of display are very high, far greater than those of an HDD readout which is not subject to the same constraints. Generally, the maximum luminance and the contrast of an HUD display are ten times greater than those of an HDD.

Fourth Advantage: Adapted Symbology

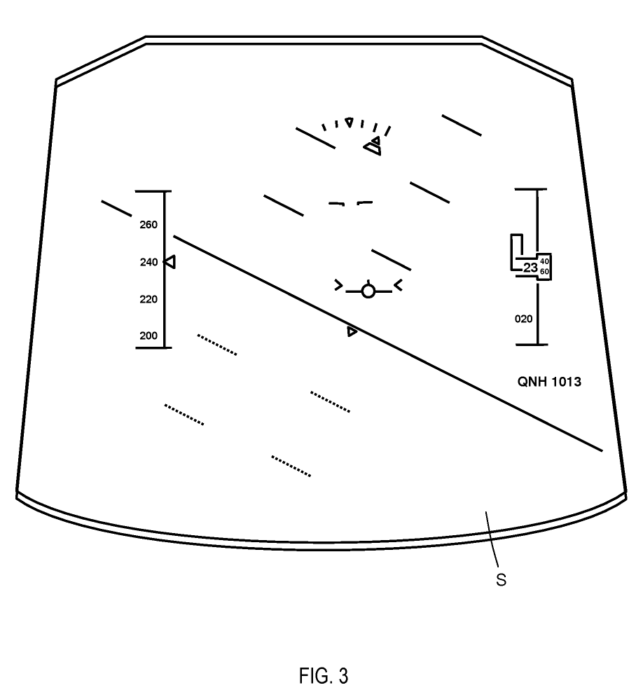

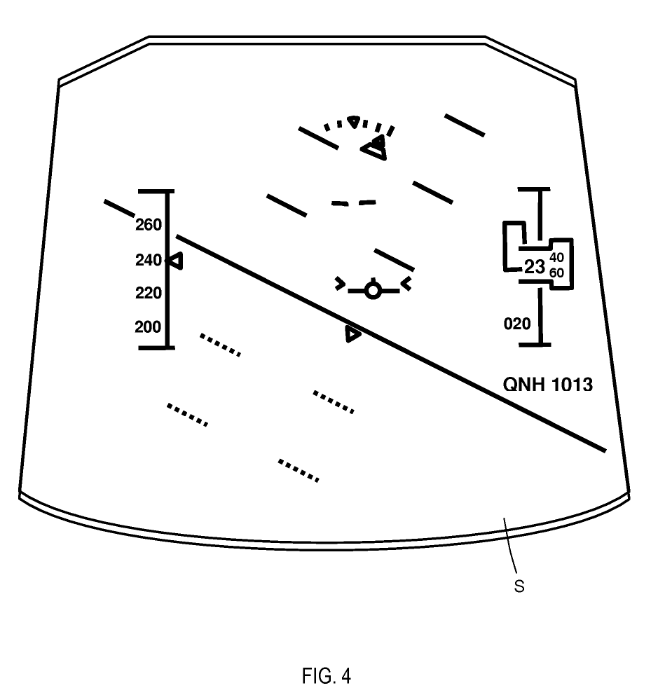

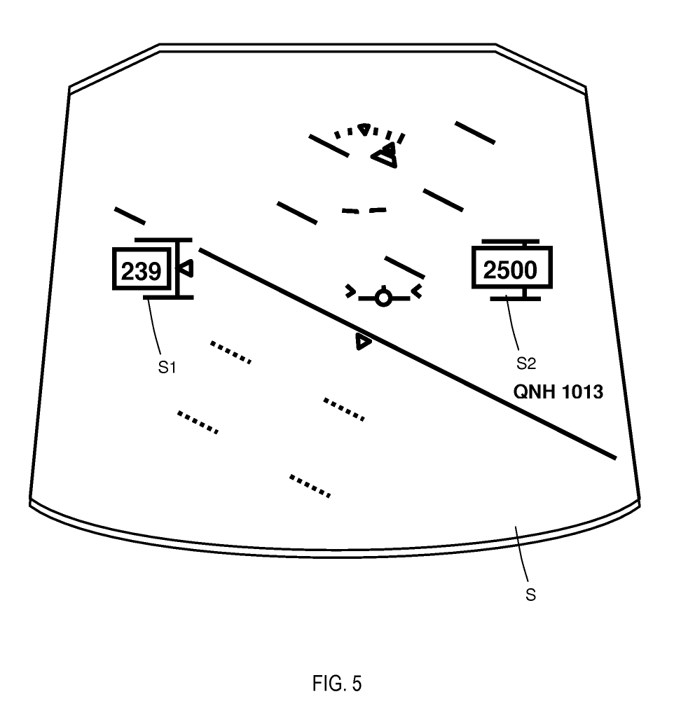

It is possible to adapt the symbology to make it as legible as possible in case of the presence of smoke. It is possible to easily adjust two parameters, namely:
Plot width. Typically, the plot width of the symbology of a head-up display is of the order of a milliradian; it is possible to significantly widen this width to improve legibility. FIGS. 3 and 4 thus present two symbologies S, the first with a normal plot, the second with a plot with a width that has been multiplied by 2;
The lightening and the simplification of the symbology. Thus, in FIG. 5, the scales indicating speeds S1 on the left and altitude S2 on the right of the symbology S of FIG. 5 have been replaced by simple speed and altitude indications written in larger characters.

Fifth Advantage: Conforming Symbology

It is possible to retain certain display functions of the HUD display. These so-called “conforming” symbols are representative of the outside landscape and drawn so that they have an apparent size to the same scale as said outside landscape and are overlaid on it.

Thus, it is possible to significantly, and at the cost of minor modifications, improve the legibility of the essential information in case of smoke in the cockpit by presenting the information in the head-up display.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A head-up display for aircraft, comprising means of calculating a PFD symbology comprising at least aircraft speed, altitude and attitude information, the head-up display being a display instrument integrated and fixed in the cockpit and presenting a collimated image.

2. The head-up display for aircraft as claimed in claim 1, wherein the calculation means generate several possible symbology presentation modes, at least one of the modes generating a simplified symbology comprising only the speed, altitude and attitude information.

3. The head-up display for aircraft as claimed in claim 1, wherein the calculation means generate plots with an angular width of between 5 milliradians and 10 milliradians.

4. The head-up display for aircraft as claimed in claim 1, wherein the calculation means generate so-called “conforming” symbols, that is, symbols representative of the outside landscape and drawn so that they have an apparent size to the same scale as said outside landscape.

5. The head-up display for aircraft as claimed in claim 1, wherein the luminance of the displayed symbols is the maximum luminance permitted by the display.

6. The head-up display for aircraft as claimed in claim 2, wherein the calculation means generate plots with an angular width of between 5 milliradians and 10 milliradians.

7. The head-up display for aircraft as claimed in claim 2, wherein the luminance of the displayed symbols is the maximum luminance permitted by the display.
